(19) United States
(12) Patent Application Publication
(10) Pub. No.: US 2006/0038788 A1
(43) Pub. Date: Feb. 23, 2006

(54) Flexible folded waterproof keybaord with a light-emitting function

(75) Inventor: Fu-Chen Tai, Taipei (TW)

Correspondence Address: TROXELL LAW OFFICE PLLC;SUITE 1404, 5205 LEESBURG PIKE, FALLS CHURCH, VA, 22041, US

(73) Assignee: Well Glory Technology Co., Ltd.

(21) Appl. No.: 10/922,901

(22) Filed: Aug. 23, 2004

(51) Int. Cl. G09G 5/00

(52) U.S. Cl. 345/168

(57) ABSTRACT

A flexible folded waterproof keyboard with a light-emitting function is disclosed. Each key on a keyboard is installed with an elastic touch-movable layer; and a thin film circuit board is installed on the elastic touch-movable layer. A light-emitting element is formed above the thin film circuit board; and the light-emitting element is an EL luminescence plate. Each luminescence plate is formed with a respective light-emitting region with respect to each key. A circuit of the luminescence plate is connected to a light-emitting control unit; in a dark, the light-emitting control unit is actuated so that the whole keyboard will light up. Furthermore, the keyboard can be washed when it is dirty for using.

### BACKGROUND OF THE INVENTION

1. Field of the Invention

The present invention relates to a flexible folded waterproof keyboard with a light-emitting function, and especially to a keyboard structure in which light can be emitted out in dark so that the computer keyboard can be operated directly and has the waterproof function.

2. Description of the Prior Art

The prior art keyboard has a hard casing and hard keys, in which the panel and bottom plate of the keyboard are made of hard material so as to be collision-tolerable. Each key formed by a key hat, an elastic body and a circuit. In general, the key hat has a color matching to the panel and the surface of the key hat is printed with characters or symbols. Furthermore, the key is made by opaque material, and thus it is only viewed in a light place. However, many peoples must see the panel of the keyboard in typewriting, especially Chinese typewriting because most peoples are not skillful in Chinese typewriting. Moreover, some people are necessary in a dark space, for example, in the bedroom, it is possible that roommates have slept, while one is necessary to use a computer. In this condition, illumination is often insufficient because not to interfere other peoples. Therefore, the error rate is high in typewriting. In general, despite the kinds of computers, such as personal computers, notebook computers, or laptop computers, the aforementioned problem exists.

Therefore, there is a novel keyboard designed which can resolve the aforesaid problem so that the user may typewrite in a dark space.

### SUMMARY OF THE INVENTION

Accordingly, the primary object of the present invention is to provide a flexible folded waterproof keyboard with a light-emitting function, each key on the keyboard may emit sufficient light for illumination through a luminescence plate, so that the characters and symbols on each key can be seen clearly. Therefore, the keyboard according to the present invention can be used in a dark environment.

Another object of the present invention is to provide the folded function of the keyboard wherein the keyboard structure is suitable for a curved and portable flexible keyboard.

A further object of the present invention is to provide the waterproof function of the keyboard wherein keyboard structure is suitable for washing when it is dirty.

To achieve the object, the present invention provides a flexible folded waterproof function of a keyboard. Each key on the keyboard is installed with an elastic touch-movable layer; and a thin film circuit board is installed on the elastic touch-movable layer. A light-emitting element is formed above the thin film circuit board and the light-emitting element is an EL luminescence plate. Each luminescence plate is formed with a respective light-emitting region with respect to each key. A circuit of the luminescence plate is connected to a light-emitting control unit. In a dark, the light-emitting control unit is actuated so that the whole keyboard will light up. The keyboard has an elastic upper cover and an elastic bottom plate for being formed folded to be carried. Furthermore, the keyboard can be washed when it is dirty for using.

The various objects and advantages of the present invention will be more readily understood from the following detailed description when reading in conjunction with the appended drawing.

### BRIEF DESCRIPTION OF THE DRAWINGS

FIG. 1 is an exploded perspective view of the present invention.

FIG. 2 is a cross sectional view of a key shown in FIG. 1.

FIG. 3 is an assembly view of the present invention.

### DETAILED DESCRIPTION OF PREFERRED EMBODIMENTS

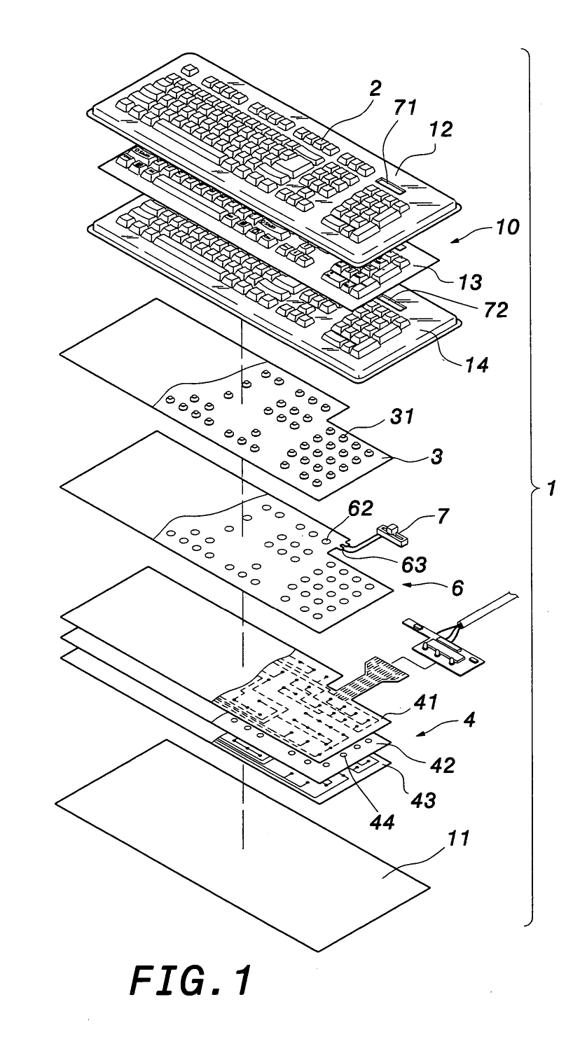

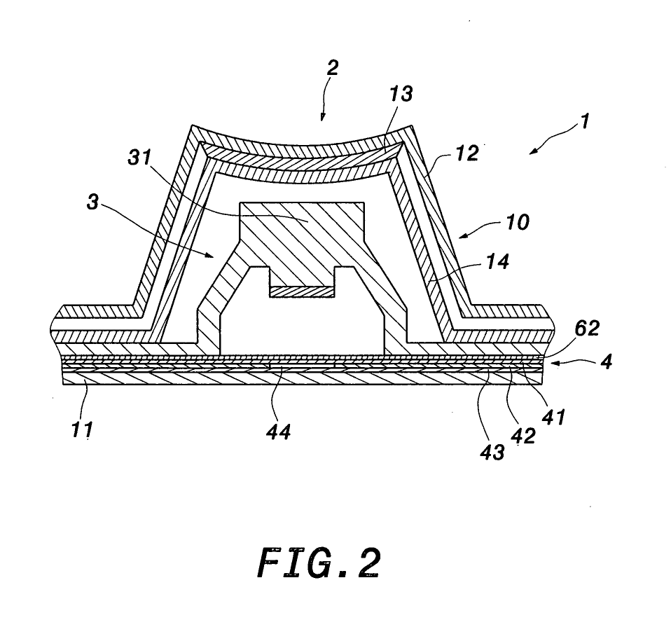

With reference to FIG. 1 to FIG. 3, a flexible folded waterproof keyboard with a light-emitting function according to the present invention is illustrated. An upper cover 10 made of a flexible and waterproof material, and having a upper film 12, a lower film 14 and a flexible sheet 13 disposed between the upper film 12 and the lower film 14, the upper film 12 having a plurality of transparent protrusions projected thereon, the flexible sheet 13 and the lower film 14 respectively having a plurality of protrusions projected thereon and correspondingly to the transparent protrusions.

An elastic touch-movable layer 3 disposed under the upper cover 10 and made of flexible and waterproof material, a light-emitting element 6 disposed under the elastic touch-movable layer 3. A light-emitting control unit 7 electrically connected to the light-emitting element 6 and having three operational modes as a touching control mode, a light-sensing control mode and a voice control mode.

A thin film circuit board 4 disposed under the elastic touch-movable layer 3 and made of flexible and waterproof material, a bottom plate 11 disposed under the thin film circuit board 4 and made of flexible and waterproof material. Wherein, the upper cover 10 connects closely with the bottom plate 11 and the upper cover 10 connects closely with the light-emitting control unit 7 so as to achieve the waterproof function.

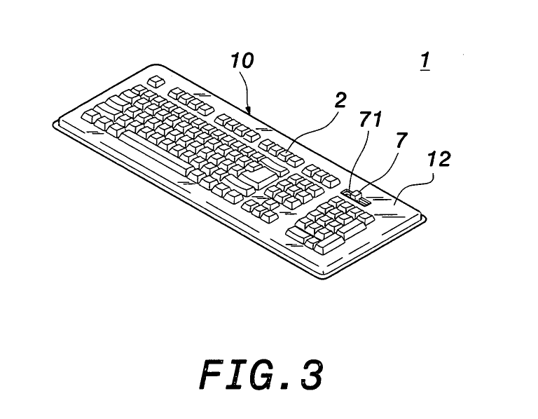

The keyboard 1 has an elastic upper cover 10 and an elastic bottom plate 11. Part of the key 2 is integrally formed with upwards protruded lattice portion. The upper cover 10 formed to be clamped between an upper film 12 and a lower film 14. A flexible sheet 13 pressed between the upper film 12 and the lower film 14. The character of each key printed on the flexible sheet 13 and the structure of the upper cover 10 made by punching. The elastic touch-movable layer 3 is a sheet shape and the elastic touch-movable layer 3 is protruded with a touch-movable body 31. The touch-movable body 31 can electrically touch the thin film circuit board 4 so as to guide a signal. In general, the thin film circuit board 4 has three layers. An upper layer 41 has a circuit printed in the inner surface, a middle layer 42 has a plurality of through holes 44 with respective to each touch-movable body 31 and the inner surface of the lower layer 43 is printed with a circuit. As the upper and lower circuits are contacted with one another, then the two circuits are conductive. Since one side of the thin film circuit 4 is connected to a strip-like flexible circuit board to output signal. The feature of the present invention is that the thin film light-emitting element 6 is added to the thin film circuit board 4. The light-emitting element 6 is a luminescence plate 62. The outer sides of the upper and lower sides of the luminescence plate 62 enclosed by transparent films. The inner surface of the luminescence plate 62 installed with a circuit at position with respect to each key 2. A conductive light-emitting body formed by dielectric and fluorescent material is installed on the key 2. Similarly, as pressing the light-emitting control key 7 at the two joints 63 of the circuit on the luminescence plate 62, the luminescence plate 62 still lights up. As the key is pressed, the touch-movable body 31 of the elastic touch-movable layer 3 will bend to depress the thin film circuit board 4 through the luminescence plate 62 to transfer signal. Since the whole structure is elastic, it can be curled for being carried, the peripheries of the upper cover 10 and the bottom plate 11 are combined by high frequency welding so as to be formed with a waterproof structure. With respect to the light-emitting control unit 7, the upper film 12 is formed with an upper through hole 71, while the lower film 14 is installed with a lower through hole 72. Further, as shown in FIG. 3, the second of the present invention is illustrated, in which the upper cover 10 is only a one-layered structure. Furthermore, characters or symbols are directly printed on the key 2 protruded from the transparent upper cover 10.

The aforesaid light-emitting structure is embodied to a general keyboard 1. The lower side of the elastic touch-movable layer 3 is a luminescence plate 62. The lower side of the luminescence plate 62 is connected to a thin film circuit board 4. Further, a light-emitting control unit 7 is installed.

In summary, in the present invention, light-emitting elements are added to a keyboard. By a light-emitting control unit to control the lighting up of the light-emitting elements, the light-emitting element installed exactly below the keyboard, and therefore, sufficient illumination is provided. Furthermore, since the keys are transparent, a good use is provided even in a dark environment outdoors or indoors.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications intended to be embraced within the scope of the invention as defined in the appended claims.

What is claimed is:

1. A flexible folded waterproof keyboard with a light-emitting function, comprising:
an upper cover made of a flexible and waterproof material, and having a upper film, a lower film and a flexible sheet disposed between the upper film and the lower film, the upper film having a plurality of transparent protrusions projected thereon, the flexible sheet and the lower film respectively having a plurality of protrusions projected thereon and correspondingly to the transparent protrusions;
an elastic touch-movable layer disposed under the upper cover and made of flexible and waterproof material;
a light-emitting element disposed under the elastic touch-movable layer;
a light-emitting control unit electrically connected to the light-emitting element and having three operational modes as a touching control mode, a light-sensing control mode and a voice control mode;
a thin film circuit board disposed under the elastic touch-movable layer and made of flexible and waterproof material; and
a bottom plate disposed under the thin film circuit board and made of flexible and waterproof material.

2. The flexible folded waterproof keyboard as claimed in claim 1, wherein the elastic touch-movable layer has a plurality of touch-movable bodies protruded thereon and correspondingly to protrusions.

3. The flexible folded waterproof keyboard as claimed in claim 1, wherein the light-emitting element has a plurality of light-emitting regions disposed to the corresponding protrusions.

4. The flexible folded waterproof keyboard as claimed in claim 1, wherein the light-emitting element is an EL luminescence plate.

5. The flexible folded waterproof keyboard as claimed in claim 1, wherein the flexible sheet has a plurality of characters or symbols formed correspondingly thereon.
